(19) United States
(12) Patent Application Publication
(10) Pub. No.: US 2002/0157446 A1
(43) Pub. Date: Oct. 31, 2002

(54) Pressure activated calibration system for chemical sensors

(76) Inventor: John P. Dilger, Marshalltown, IA (US)

Correspondence Address: MARSHALL, GERSTEIN & BORUN, 6300 SEARS TOWER, 233 SOUTH WACKER, CHICAGO, IL, 60606-6357, US

(21) Appl. No.: 10/104,600

(22) Filed: Mar. 22, 2002

Related U.S. Application Data
(63) Continuation-in-part of application No. 09/287,245, filed on Apr. 7, 1999, now Pat. No. 6,408,674.

(51) Int. Cl. G01N 27/00

(52) U.S. Cl. 73/1.02

(57) ABSTRACT

A calibration system includes an acoustic wave gas sensor array, and a delivery device adapted to eject a measured quantity of a liquid calibrant to the gas sensor array. The delivery device includes a connector adapted for connection to an air supply source, a reservoir adapted to store a supply of the liquid material, an outlet arranged for placement adjacent to the gas sensor array, a dosing chamber sized to define and store a measured quantity of the calibrant, a conduit disposed between the dosing chamber and the reservoir and arranged to provide flow communication therebetween, a portion of the conduit arranged to be responsive to a pressure gradient within the dosing chamber over a predetermined time interval to thereby prevent flow from the dosing chamber toward the reservoir during the predetermined time period, and a valve mechanism adapted to apply the pressure gradient to the dosing chamber over the predetermined time interval.

### RELATED APPLICATION

This application is a continuation-in-part of U.S. application Ser. No. 09/287,245, filed Apr. 7, 1999.

### FIELD OF THE INVENTION

The present invention relates to calibration systems for chemical sensors and, more specifically, to a pressure actuated calibration device that delivers a metered dose of calibrant to the atmosphere immediately adjacent to the chemical sensor to be calibrated.

### BACKGROUND OF THE INVENTION

Industrial manufacturing, processing and storage facilities such as chemical plants, refineries and shipping terminals typically include a vast network of piping systems for transporting raw or finished products in liquid or gaseous form through the facility. Such piping systems necessarily include a number of valves for controlling the flow of the products through the facility.

Many of the products handled in the aforementioned plants are hazardous volatile organic compounds (VOC's). Unfortunately, the valves used to control the flow of material through the plants, may in certain circumstances, experience a certain amount of undesired leakage. Such leakage is commonly referred to as “fugitive” emissions. Fugitive emissions, which typically are subject to environmental regulations, frequently occur, for example, around the packing between the valve stem and the body of the valve. Other sources of fugitive emissions may also exist.

Fugitive emissions must be monitored in order to comply with applicable emissions regulations. Accordingly, leak detectors may be placed near the valves or other known or suspected leak sources. These detectors are usually placed closely adjacent to the leak source in order to monitor the leakage rate.

In order to obtain accurate readings, the leak detectors must be calibrated on a periodic basis. For a variety of reasons the calibration process is typically carried out from a remote location. One method of calibrating such leak detectors is to eject a small quantity of calibrant into the atmosphere immediately adjacent to the leak detector. The detector reading is then compared to a standard based on empirical data or a look up table, and the detector is adjusted accordingly. Other calibration methodology may be employed as well.

### BRIEF DESCRIPTION OF THE DRAWINGS

FIG. 1 is a schematic view, partly in section, of a leak sensor calibrating device constructed in accordance with the teachings of the present invention;

FIG. 2 is a perspective view of a remotely operable microvalve for use with a device constructed in accordance with the teachings of the present invention;

FIG. 3 is an exploded view in perspective of the microvalve shown in FIG. 2;

FIG. 4 is an enlarged top plan view of a Teflon insert having defined therein the dosing chamber;

FIG. 5 is an enlarged cross-sectional view of the Teflon insert taken along line 5-5 of FIG. 4;

FIG. 5A is an enlarged cross-sectional view similar to FIG. 5 but illustrating a Teflon insert having a conical portion at the input side of the insert;

FIG. 6 is an enlarged perspective view of a check valve adapted for use with the present invention;

FIG. 7 is a fragmentary schematic view illustrating the position of the check valve relative to the dosing chamber and the calibrant reservoir;

FIG. 8 is a schematic view, partly in section, similar to FIG. 1 but assembled according a second preferred embodiment of the invention; FIG. 9 is a schematic view of a leak sensor calibration system assembled in accordance with the teachings of another preferred embodiment of the present invention;

FIG. 10 is a schematic view in perspective of a quartz crystal microbalance sensor for use on the sensor array; and

FIG. 11 is a schematic view of in perspective of a surface acoustic wave sensor for use on the sensor array.

### DETAILED DESCRIPTION OF THE PREFERRED EMBODIMENTS

The examples described herein are not intended to limit the invention to precise form or forms disclosed. Rather, the following examples have been chosen and described in order to enable those skilled in the art to follow the teachings of the present invention.

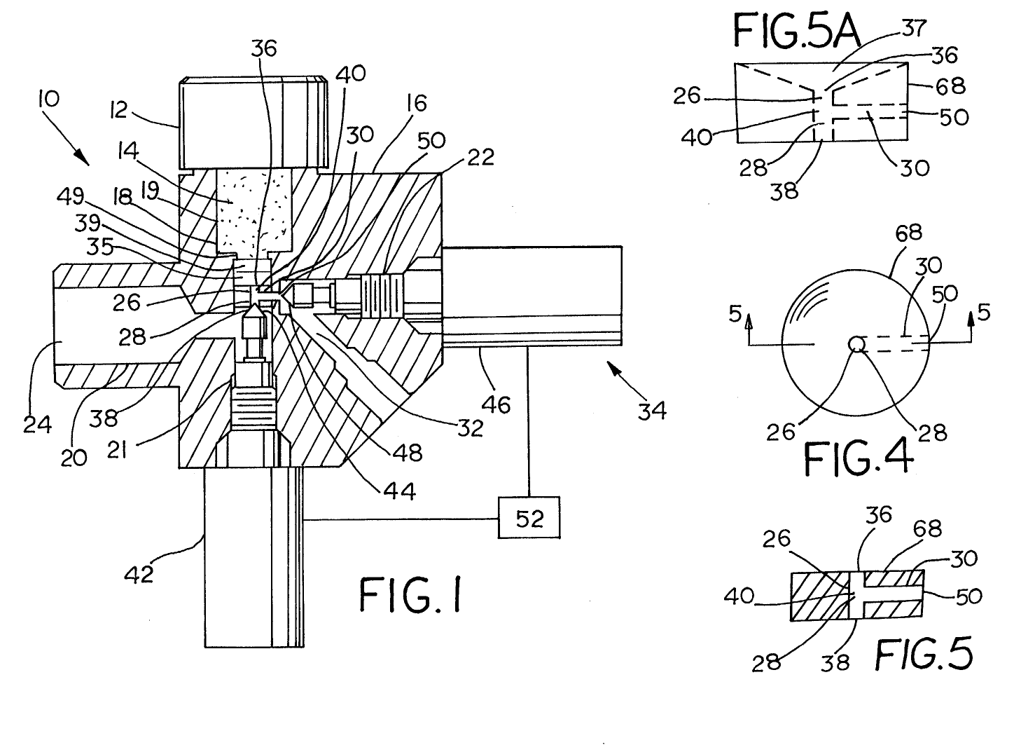

Referring now to FIG. 1 of the drawings, a leak sensor calibrating device constructed in accordance with the teachings of a first example of the present invention is generally referred to by the reference numeral 10. In at least one possible preferred environment of use, the calibrating device 10 is typically placed closely adjacent to the system which is to be monitored for leakage, such as a valve, a pipe system or seal, or any other potential emission source (not shown). The device 10 includes a reservoir 12 which contains a quantity of analyte calibrant 14, which is preferably the same material as is running through the valve or other system component (not shown) to be monitored. As explained in further detail below, the analyte calibrant 14 may be in either a liquid phase or in a vapor phase.

The device 10 includes a body or housing 16 having a plurality of intersecting conduits or bores 18, 20 and 22. The housing 16 is preferably manufactured of stainless steel or other suitable materials. The bore 18 includes first and second sections 19, 21, respectively. The bore 18 extends substantially through the housing 16 and is in flow communication with the reservoir 12 and the bore 20. The bore 20 extends to the bore 18 and is in flow communication with an outlet nozzle 24. The outlet nozzle 24 will preferably be placed closely adjacent to the valve (or other system component) to be monitored for leakage (not shown). A bore 26 connects the bores 18 and 20, and defines a dosing chamber 28. The dosing chamber 28 is preferably of a predetermined volume. For example, in the event the analyte calibrant 14 is to be utilized in a liquid phase, the volume of the dosing chamber 28 may be in the range of 2 microliters (2×10⁻³ cubic centimeters). By comparison, in the event the analyte calibrant 14 is to be utilized in a vapor phase, the volume of the dosing chamber 28 may be in the range of 500 microliters (500×10⁻³ cubic centimeters). Other volumes may be contemplated, as long as the dosing chamber 28 stores the predetermined volume of calibrant 14. The desired amount or volume of calibrant 14 to be ejected from the outlet nozzle 24 may be chosen based on a number of factors, including the type, concentration, purity, and state (i.e., liquid or vapor) of the chosen calibrant, as well as the temperature, humidity, etc. of the surrounding environment, all of which would be well known to those of skill in the art. The desired amount of calibrant 14 to be ejected can be increased or decreased by changing the volume of the dosing chamber 28.

As shown in FIGS. 1, 4 and 5, a bore 30 connects the bore 22 with the dosing chamber 28, and an air supply inlet 32 intersects the bore 22. The air supply inlet is connected to a source of pressurized air (not shown), the purpose of which will be explained in greater detail below. Preferably, the air is supplied from the supply source at approximately 3 psig, with appropriate deviations therefrom being possible as would be contemplated by those skilled in the art. The device 10 includes a valving mechanism 34 which, as will be explained in greater detail below, is adapted to eject a desired quantity of calibrant 14 from the dosing chamber 28 through the outlet nozzle 24.

The dosing chamber 28 includes an input end 36, an output end 38, and an intermediate portion 40 as shown in FIG. 5. The bore 30 intersects the dosing chamber 28 at the intermediate portion 40. As shown in FIG. 5A, the input end 36 of the bore 26 may alternatively include a flared or conical portion 37.

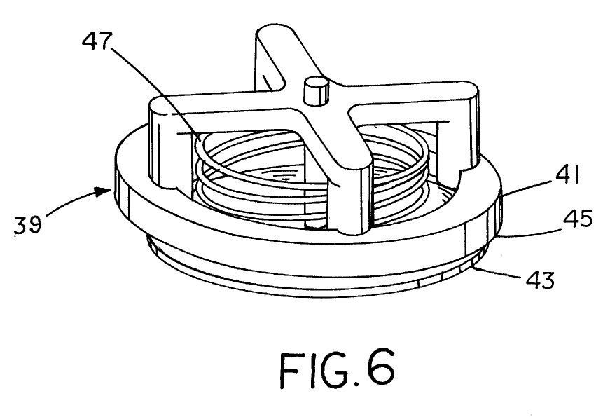

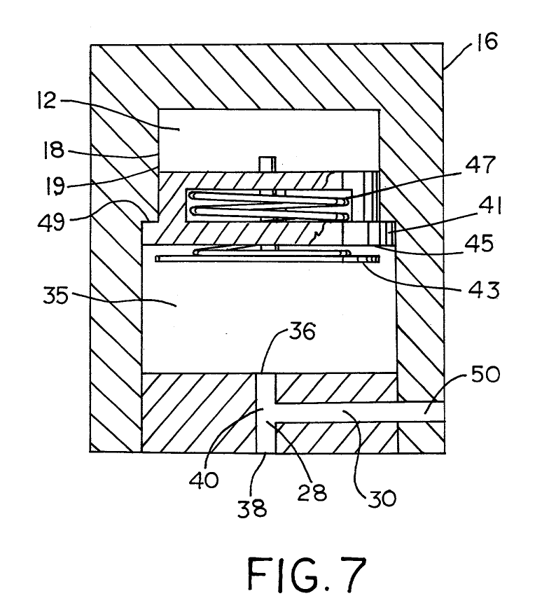

As shown in FIG. 1, a check valve 39 is disposed in the portion 19 of the bore 18 generally adjacent to the input end 36 of the dosing chamber 28. Referring to FIGS. 6 and 7, the check valve 39 includes a housing 41 sized to be received in the portion 19 of the bore 21. The check valve 39 includes a plate or disc 43 which is sized to be received against a valve seat 45, and further includes a spring 47 for biasing the disc 43 toward a normally open position as shown in FIG. 7. As can be seen in FIG. 7, the portion 19 of the bore 18 may include an annular seat 49, enabling the check valve 39 to be pressed into place (for example, from below when viewing FIG. 7).

When the valving mechanism 34 is activated in the manner to be described in greater detail below, the introduction of the actuation pressure against the disc 43 causes the disk 43 to move upwardly (when viewing the FIGS.) such that the disc 43 is seated against the valve seat 45. Accordingly, any flow of the calibrant 14 back toward the reservoir 12 is prevented. It will be noted that the check valve 39 is thus operated automatically in response to the operation of the valving mechanism 34, and will further behave as a bi-stable check valve. As will be noted from FIG. 7, the check valve 39 is preferably located slightly away from the input end 36 of the bore 26 so as to define a chamber 35. It will be understood that the volume of the reservoir 12 is preferably much greater than the volume of the dosing chamber 28, in order to facilitate rapid refilling of the dosing chamber 28 after the measured quantity stored therein has been ejected through the outlet nozzle. In the preferred embodiment, the volume of the reservoir 12 may be approximately twenty (20) times the volume of the dosing chamber 28.

Referring again to FIGS. 1, 2 and 3, the valve mechanism 34 includes a first valve 42 disposed in the section 21 of the bore 18. The valve 42 includes a tip 44 adapted to close off the outlet end 38 of the dosing chamber 28. The valve mechanism 34 also includes a second valve 46 disposed in the bore 22 and having a tip 48 adapted to close off an inlet end 50 of the bore 30. Each of the valves 42 and 46 is shiftable between closed and open positions. When the valve 42 is in a closed position, the valve 42 isolates the dosing chamber 28 from the outlet nozzle 24. When the valve 42 is in an open position, the dosing chamber 28 is in flow communication with the outlet nozzle 24. When the second valve 46 is in the closed position, the valve 46 isolates the air inlet 32 from the dosing chamber 28. When the valve 46 is in the open position, the air inlet 32 is in flow communication with the dosing chamber 28. Preferably, each of the valves 42 and 46 is a remotely operable, electrically actuated microvalve. Still preferably, each of the valves 42, 46 are remotely operable from a common control system 52.

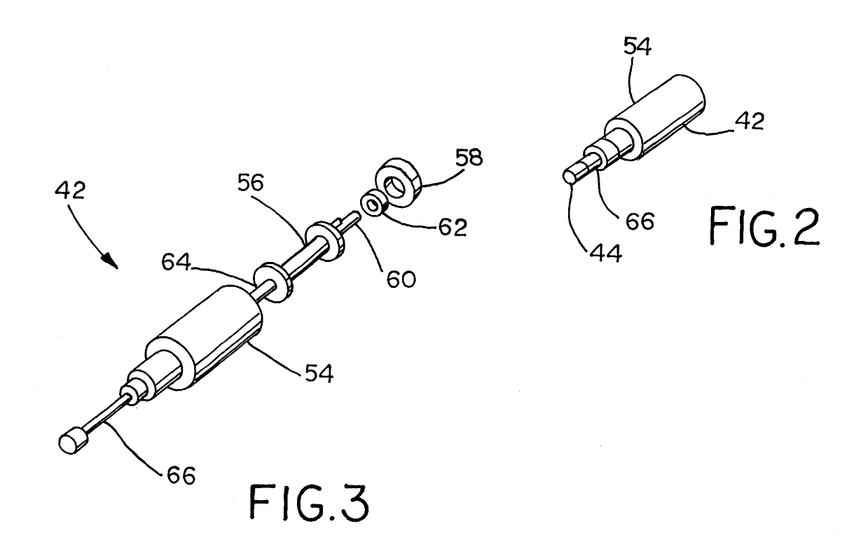

Referring now to FIGS. 2 and 3, the valve 42 is shown. It will be understood that the structure and operation of the valve 46 is substantially the same. However, only the structure and operation of the valve 42 will be described in detail. The valve 42 includes a body 54, an electromagnetic bobbin 56, a pair of soft magnetic pole pieces 58, 60, a rare earth permanent magnet 62 an insulator 64 and an armature 66. The valve body 54, the pole pieces 58, 60, and the armature 66 are preferably constructed using 17-4 stainless steel, while the insulator 64 is preferably constructed of 316 stainless steel. The magnet 62 is preferably constructed of Nickel Iron Boron. The valves 42 and 46 are preferably electrically operable valves, having a six (6) volt actuation energy drawing 250 mA at 10 milliseconds. Other suitable valves may be substituted.

Referring now to FIGS. 1 and 4, a Teflon® insert 68 may be used at the intersection of the bores 18, 20 and 22. The Teflon insert 68 is preferably compression molded using known techniques, so as to have defined therein the dosing chamber 28 and the bore 30. The use of a separate insert 68 greatly eases the manufacturing process by permitting the housing 16 to be manufactured to a first set of tolerances, while the insert 68 is manufactured to a second, more rigorous set of tolerances. The insert 68 also provides a better seal at the tip 44 and 48 of the valves 42 and 46, respectively.

In operation, when the device 10 is inactive, the valves 42 and 46 are both closed, and the calibrant 14 in reservoir 12 is free to flow into the dosing chamber 28 by virtue of the fact that the check valve 39 is in an open position. When it is desired to activate the device 10, the control system 52 first opens the valve 46, preferably for a period of 50 milliseconds. While the valve 46 is open, the control system 52 next opens the valve 42, which permits the pressurized air from the air source to flow through the air inlet 32. The resulting pressure increase causes the check valve 39 to immediately shift to its closed position. The incoming air acts to displace the measured quantity of calibrant 14 stored in the dosing chamber 28, causing the measured quantity to be ejected from the outlet nozzle 24. By virtue of the check valve 39 moving to its closed position upon the introduction of the actuation pressure, any flow of calibrant 14 from the dosing chamber 28 toward the reservoir 12 is prevented, and the calibrant 14 in the dosing chamber 28 is ejected out of the outlet nozzle 24. After the desired 10 millisecond interval, the valve 42 is closed. Shortly thereafter, valve 46 is closed. With the actuation pressure closed off, the check valve 39 returns to its normal open position aided by the force of the spring 47, and calibrant 14 is free to flow from the reservoir into the dosing chamber 28.

In the process, the exhausted calibrant 14 is mixed with a known quantity of atmosphere from around a process system valve (not shown) for the purpose of measuring or predicting the leak emissions from the valve. The leak sensor (not shown) can be calibrated by comparing the obtained sensor reading to empirical data, or by using other known methods.

It will be noted by those skilled in the art that it may be advantageous to use the calibrant 14 in its vapor state. When using a vaporized calibrant 14 within the device 10, the potential for leakage at each of the valves 42, 46 is greatly minimized, especially when the device 10 is used in high temperature environments. In the event a vaporized calibrant is used, the leak sensor (not shown) may be calibrated by taking into consideration the surrounding temperature and the vapor pressure of the calibrant in order to calculate the entrained quantity of calibrant ejected from the outlet nozzle 24.

It will also be noted by those skilled in the art that, using the same principles discussed hereinabove, the present device 10 may be used in order to periodically test the constituency or purity of a substance flowing through a pipeline or other conveyance in an industrial process system (not shown). In such an application, the reservoir 14 would be in constant flow communication with the substance flowing through the pipeline or system, and the outlet nozzle 24 would be placed in close proximity to an appropriate sensor.

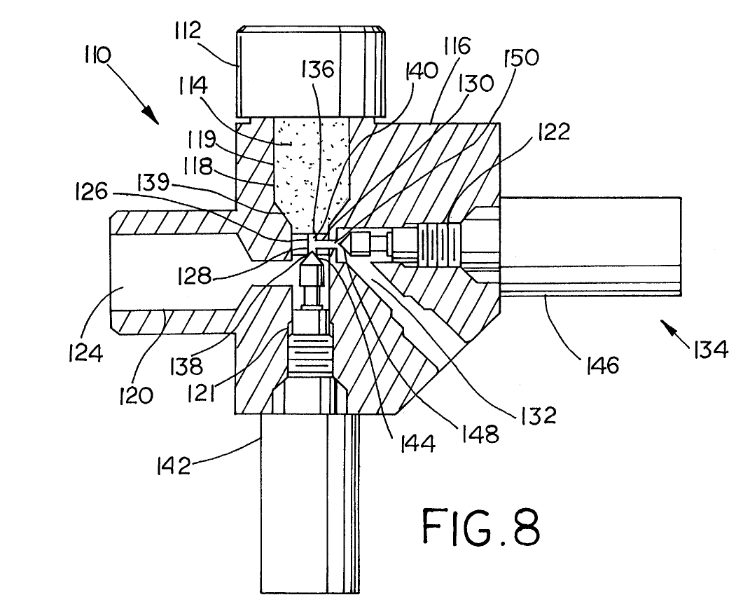

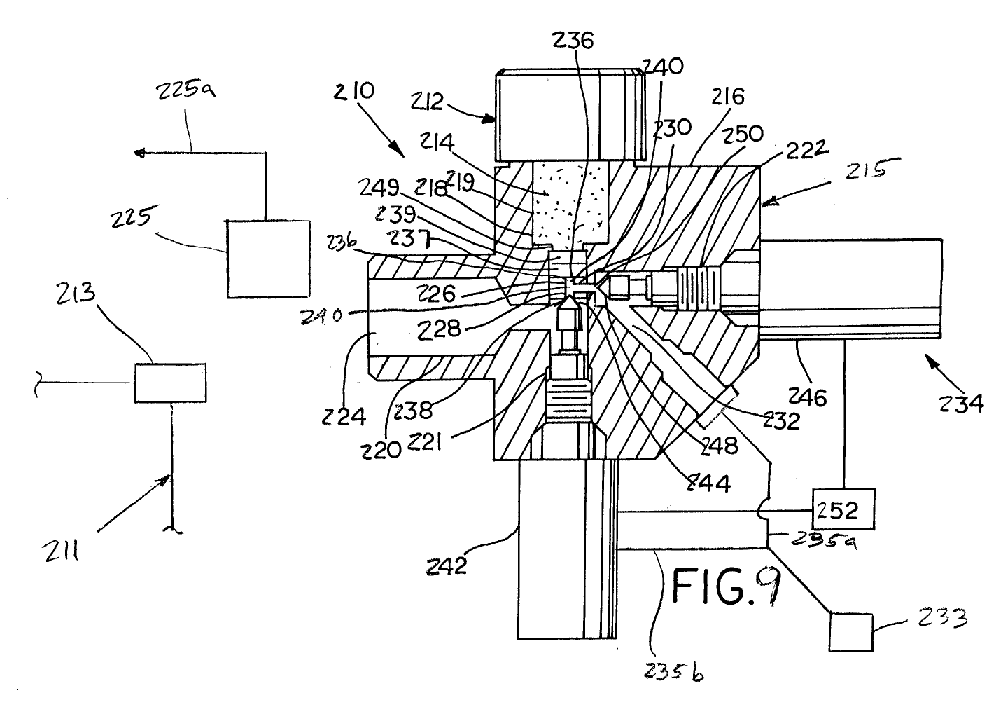

Referring now to FIG. 8, a second preferred embodiment is shown in which all elements that are the same or similar as the embodiment discussed above will retain the same reference characters, but increased by 100. A gas sensor array calibrating device 110 includes a reservoir 112 which contains a quantity of analyte calibrant 114. The device 110 includes a body or housing 116 having a plurality of intersecting conduits or bores 118, 120 and 122. The bore 118 includes first and second sections 119, 121, respectively, and extends substantially through the housing 116. The bore 120 extends to the bore 118 and is in flow communication with an outlet nozzle 124. A bore 126 connects the bores 118 and 120, and defines a dosing chamber 128. The dosing chamber 128 will store a predetermined volume of calibrant 14, with the predetermined or desired amount being determined by the internal volume of the dosing chamber 28.

A bore 130 connects the bore 122 with the dosing chamber 128, and an air supply inlet 132 intersects the bore 122. The air supply inlet 132 is connected to a source of pressurized air, which is supplied from a supply source at approximately 3 psig. The device 110 includes a valving mechanism 134 having a first valve 142 disposed in the section 121 of the bore 118 and further having a tip 144 adapted to close off the outlet end 138 of the dosing chamber 128. The valve mechanism 134 also includes a second valve 146 disposed in the bore 122 and having a tip 148 adapted to close off an inlet end 150 of the bore 130. The valving mechanism 134 is operable in a manner similar to that described above with respect to the first preferred embodiment.

The dosing chamber 128 includes an input end 136, an output end 138, and an intermediate portion 140. The bore 130 intersects the dosing chamber 128 at the intermediate portion 140. The bore 118 includes a section 139, with the section 139 being disposed adjacent the input end 136 of the dosing chamber 128. The section 139 has a diameter greater than the diameter of the dosing chamber 128, such that the section 139 functions as a pneumatic restriction. Although the bore 118 is shown as having two sections of different diameter, the bore 118 alternatively may be of uniform diameter, as long as the cross-sectional area of the section 139 immediately adjacent to the input end 136 of the dosing chamber 128 is significantly greater than the cross-sectional area of the dosing chamber 128. This difference in cross-sectional area ensures that the volume of calibrant disposed in the section 139 of the bore 118 immediately adjacent to the input end 136 of the dosing chamber 128 is significantly greater than the volume of calibrant stored in the dosing chamber 128. Accordingly, in response to the operation of the valving mechanism 134 and the introduction of the actuation pressure to the calibrant 114 stored in the dosing chamber 128, the calibrant 114 will follow the path of least pneumatic resistance and will thus be ejected from the outlet nozzle 124.

Referring now to FIG. 9, a leak sensor calibration system assembled in accordance with the teachings of another preferred example of the present invention is shown and is referred to by the reference numeral 210. The calibration system 210 is disposed adjacent to a piping system 211 having an emission source 213. As outlined above, the emission source 213 may be, for example, a valve or other non-point source. The calibration system 210 includes a delivery device 215 that delivers a measured quantity of a calibrant 214. The calibrant 214 may be an analyte calibrant in either a liquid or vapor phase. Alternatively, the delivery device 215 may be attached to the piping system 211, and arranged to deliver a quantity of material in either a vapor or liquid phase flowing through the piping system to a sensor for the purpose of determining the constituency of the material flowing through the piping system 211.

The delivery device 215 includes a reservoir 212 which contains a quantity of the calibrant 214. As outlined above, the calibrant 214 may be the same material as is flowing through the piping system 211 and which may be exiting the piping system 211 at the emission source 213. The delivery device 215 includes a body or housing 216 having a plurality of intersecting conduits or bores 218, 220, and 222. The housing 216 is preferably manufactured of stainless steel or other suitable materials. The bore 218 preferably includes a first section 219 and a second section 221, and is in flow communication with the reservoir 212 and with the bore 220. The bore 220 is in flow communication with an outlet nozzle 224. The outlet nozzle 224 will preferably be placed closely adjacent to a gas sensor array 225.

A portion 226 of the bore 220 defines a dosing chamber 228. In the example shown, the portion 226 of the bore 218 and hence the dosing chamber 228 are shown generally disposed in or part of the bore 218. Alternatively, the housing 216 and the intersecting bores may be configured as necessary with the dosing chamber 228 disposed in another one of the bores.

As outlined above with respect to the preceding examples, the dosing chamber 228 has a known volume. Also as outlined above, the known volume of the dosing chamber 228 may be in the range of 2 microliters (2×10⁻³ cc). Other volumes may be contemplated, depending on whether the calibrant 214 is to be used in a liquid phase or in a vapor phase. Other factors affecting the desired volume of the dosing chamber 228 are outlined above with respect to the preceding examples.

A bore 230 connects the bore 222 with the bore 218. In the disclosed example, the bore 230 communicates directly with the dosing chamber 228. An air inlet 232 is provided, and in the disclosed example intersects the bore 230 and is connected to an air supply source 233. The air supply source 233 may include a manifold 235 and a plurality of supply lines 235a, 235b as required. In the disclosed example, the air supply source 233 may be arranged to supply air at a gauge pressure in the range of about 3-6 psig, more preferably about 3 psig. Those skilled in the art will understand that minor deviations from the preferred range may be tolerated keeping in mind that, as the pressure becomes too low problems with adequate atomization may arise. On the other, as the pressure becomes too high backflow through the reservoir may become a problem. Additionally, as pressures become too proper valve actuation may be inhibited. A valve system 234 is provided and is arranged to eject the measured quantity contained in the dosing chamber 228 through the outlet nozzle 224 in a manner similar to that described above with respect to the preceding examples.

The dosing chamber 228 includes an input end 236, an output end 238, and an intermediate portion 240. In the disclosed example, the bore 230 intersects the dosing chamber 228 at the intermediate portion 240. The arrangement of the bores at the point of intersection may be similar to that outlined above in FIG. 5A with respect to the first disclosed example.

An expanded portion 237 of the bore 218 is provided immediately adjacent to the dosing chamber 228, with the portion 237 being disposed between the dosing chamber 228 and the reservoir 212. As will be explained in greater detail below, the volume contained in the portion 237 of the bore 218 is preferably sufficiently greater than the predetermined volume contained in the dosing chamber 228 such that, when the delivery device 215 is filled with calibrant 214, the volume of calibrant 214 contained in the portion 237 will be substantially immobile in response to the introduction of a brief pressure gradient as will be outlined in greater detail below. It will be understood that there will be a threshold ratio of the cross-sectional area of the expanded portion 237 relative to the cross-sectional area of the dosing chamber 228. This ratio should be no less than about 32:1, and need not be greater than about 80:1. If the restrictive ratio is greater than about 80:1, response times for re-filling the dosing chamber may increase unnecessarily, and/or valve sealing requirements (i.e., greater closure force) may be required. This threshold ratio may change as the actuation pressure and pressure gradients change. Consequently, by virtue of the volume difference between the dosing chamber 228 and the portion 237, the portion 237 will serve as a pneumatic barrier or restriction and prevent flow of calibrant 214 from the dosing chamber 228 toward the reservoir 212.

In an alternate form, the delivery device 215 may be provided with a check valve 239. The check valve 239 is preferably disposed generally adjacent to the reservoir 212, such that the portion 239 remains disposed between the check valve 239 and the dosing chamber 228. The check valve 239 may take the form of the check valve described above with respect to the preceding examples.

The valve mechanism 234 includes a first valve 242 disposed in the bore 218 such that the valve 242 effectively seals the dosing chamber 228 from the outlet nozzle 224, thus isolating the calibrant 214 contained in the dosing chamber 228 from the atmosphere and hence from the gas sensor array 225. The valve 242 includes a tip 244 sized to seal the output end 238 of the dosing chamber 228. The valve mechanism 234 also includes a second valve 246 disposed in the bore 222 and having a tip 248 sized to seal off an inlet end 250 of the bore 230. As outlined above with respect to the preceding example, when the valve 242 is in a closed position, the valve 242 isolates the dosing chamber 228 from the outlet nozzle 224. When the valve 242 is in an open position, the dosing chamber 228 is in flow communication with the outlet nozzle 224. When the valve 246 is in the closed position, the air inlet 232 is isolated from the dosing chamber 228. When the valve 246 is open, the air inlet 232 is in flow communication with the dosing chamber 228. A common control system 252 is provided for the remote operation of the valves 242 and 246. The operation of the valve system 234 may be similar to that described above with respect to the preceding examples, including the timing and duration of the valves when shifted to their respective open positions.

For example, in a preferred timing and operation sequence, the valve 242 may shift to the open position about 1 ms prior to the opening of the valve 246. The valve 242 may then remain open for about 13 ms. The valve 246 may be open for a duration of about 10 ms, thus closing about 2 ms before the closing of the valve 242. This applies a pressure head to the volume of the calibrant 214 in the dosing chamber 228. With the valve 242 in the open position a pressure head is applied to the analyte in the dosing chamber for about 1 ms. The valve 246 then cycles to the open position for the preferred duration of about 10 ms. This ejects the measured quantity of the calibrant 214 in the dosing chamber 228 through the outlet nozzle. In the disclosed example, the pressure provided by the air supply 233 and the timing of the valve system 234 is sufficient to apply a pressure gradient of about 300-500 psig per second to the calibrant 214 in the dosing chamber 228, with a pressure gradient of about 300 psig per second being preferred. This pressure gradient is sufficient to eject the measured quantity in the dosing chamber 228, but is sufficiently brief so as to not overcome the pneumatic restrictive effect of the calibrant material contained in the expanded portion 237 adjacent to the dosing chamber 228.

The gas sensor array 225 may be, by way of example rather than limitation, an acoustic wave sensor. The gas sensor array 225 is arranged to provide an appropriate output signal 225a as would be known. The output signal 225a is indicative of the presence and amount of calibrant 214 sensed in the vicinity of the gas sensor array 225.

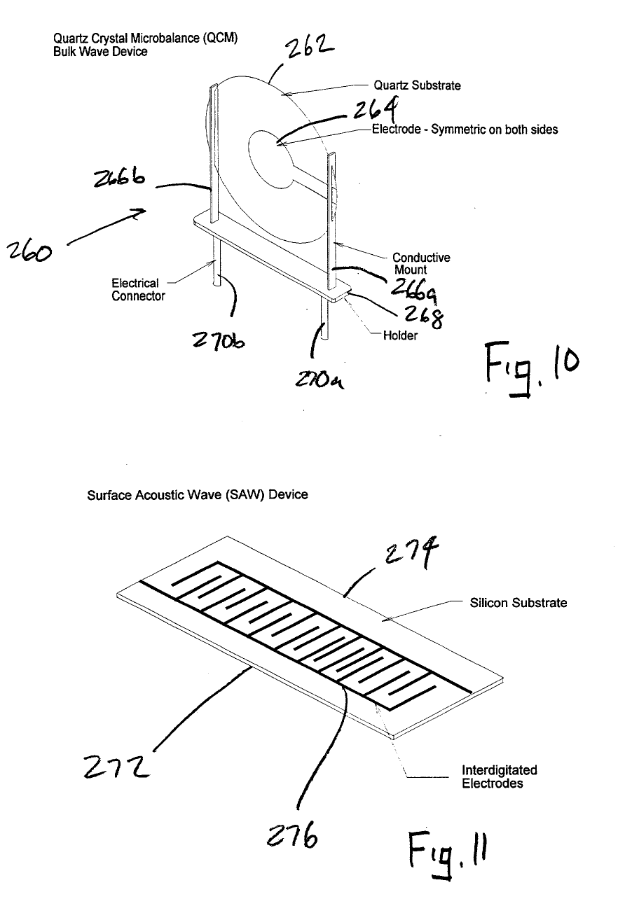

Referring now to FIG. 10, the acoustic wave sensor may take the form of a quartz crystal microbalance bulk wave device (hereinafter “QCM”) 260. The QCM 260 includes a quartz substrate 262, a symmetric electrode 264, and a pair of conductive mounts 266a, 266b. The quartz substrate 262 and the mounts 266a and 266b are supported on a holder 268. A pair of electrical connectors 270a and 270b are provided, which are operatively connected to appropriate circuitry (not shown) in a known manner in order to provide the output signal 225a.

Alternatively, and referring now to FIG. 11, the acoustic wave sensor may take the form of a surface acoustic wave (SAW) device 272. The SAW device 272 includes a silicon substrate 274 having a network of interdigitated electrodes 276. The interdigitated electrodes 276 are in operative connection with appropriate circuitry (not shown) in a known manner in order to provide the output signal 225a.

In accordance with the disclosed example, precise calibration of the gas sensor array 225 is desired such that accurate analytical quantification can be performed in the field. The acoustic wave device includes an overlayer deposited on at least one side of the substrate with the electrodes positioned on, for example, the top and the bottom surface of the substrate in opposition to each other. The substrate will have piezoelectric properties such that an electric field applied across the substrate through the electrodes will induce a mechanical deformation of the substrate. When the acoustic wave sensor is placed within an oscillator circuit in a known manner, the acoustic wave sensor will generate a bulk acoustic wave within the substrate and resonate at a characteristic frequency (e. g., 15 Mhz). Generally speaking, high-resonant frequencies of the substrate are favored in order to achieve adequately sensitive measuring properties for the acoustic wave sensor. Transduction may be recorded as deviations in the frequency of the acoustic wave sensor.

For example, as the overlayer sorbs greater concentrations of the analyte, the resonant frequency of the sensor decreases. An electronic circuit may be used to measure the frequency deviations. As would be known, the overlayer may be generally comprised of one or more polymeric compounds that have a chemical affinity for the chemical of interest (e. g., the analyte). The chemical forces responsible for the attraction of the analyte to the coating are varied, and may be dependent upon both the chemistry of the coating and the analyte itself. However, it will be noted that in all cases the process is reversible (that is, the characteristic frequency of the substrate will return to its original value when the presence of the analyte is removed). The concentration of the analyte in the vicinity of the gas sensor array is directly proportional to the decrease in resonant frequency of the sensor through a limited exposure range.

As would be known, numerous variables affect the sensitivity of the acoustic wave sensor. For example, the thickness of the coating, the morphology of the coating, the ambient temperature, and the flow characteristics of the calibrant. With respect to field measurements, significant factors are ambient temperature and flow characteristics. Knowledge of these conditions is required before accurate concentration data can be acquired. The chemical interactions occurring at the coating surface ultimately alter or bias the response of the sensor. These perturbations will degrade the accuracy of the sensor.

As is known, ambient temperature has a pronounced effect on both the analyte and the overlayer applied to the substrate. The analytes (which may be, as examples rather than limitations, Toluene, Benzene, Xylene) all have vapor pressures that increase exponentially as the temperature increases. The physical manifestation of this increasing volatility is that the molecules of the analytes possess greater energy and are therefore harder to capture at the surface of the sensor. Additionally, the resonant frequency of the substrate has a temperature coefficient that will induce a bias in the measured frequency. The soft polymeric compounds used in the overlayer have characteristics of both fluids and solids. The term applied to this artifact is viscoelastic.

At elevated temperatures the coating will have physical characteristics that are more fluid or viscous in nature. On the other hand, during operation at lower temperatures, the coatings become stiffer and behave more like a solid or possess elastic characteristics. These changes in coating physiology will induce a bias signal not related to the analyte concentration, thus causing a perturbation in the measurement. Therefore, the temperature must either be controlled or measured during the exposure to ensure accurate data.

Not only does temperature effect the interactions, but the flow of the analyte also has an effect on sensor readings. The concentration of analyte is typically in the range of 1-1000 ppm. These extremely low concentrations of analyte are indicative of a carrier gas (e.g., atmosphere) being present in much larger quantities. Variations in flow will affect the apparent concentration in two ways. First, with low concentrations of analyte embedded in the carrier gas, the a non-homogenous distribution of the analyte on the sensor surface may result. Any variation in flow will induce concentration changes at the surface of the sensor and change its response. Second, variations in flow can induce temperature changes in the substrate, thus creating a bias not related to analyte concentration or ambient temperature.

It will be understood that in any of the above-discussed embodiments, the reservoir may instead be piping system containing a process stream of a fluid material, and the aforementioned device may be employed to periodically sample the purity or the constituency of the process stream by ejecting a known quantity of the fluid material to a sensing device, such as, for example, the gas sensor array 225.

It will further be understood that the above description does not limit the invention to the above-given details. It is contemplated that various modifications and substitutions can be made without departing from the spirit and scope of the following claims.

What is claimed:

1. A calibration system comprising:
a gas sensor array, the gas sensor array comprising an acoustic wave sensor;
a delivery device adapted to eject a measured quantity of a liquid calibrant to the gas sensor array, the delivery device comprising:
a connector adapted for connection to an air supply source;
a reservoir adapted to store a supply of the liquid material;
an outlet, the outlet arranged for placement adjacent to the gas sensor array;
a dosing chamber, the dosing chamber sized to define and store a measured quantity of a fluid calibrant,
a conduit disposed between the dosing chamber and the reservoir and arranged to provide flow communication therebetween, a portion of the conduit arranged to be responsive to a pressure gradient within the dosing chamber over a predetermined time interval to thereby prevent flow from the dosing chamber toward the reservoir during the predetermined time period; and
a valve mechanism adapted to apply the pressure gradient to the dosing chamber over the predetermined time interval.

2. The system of claim 1, including an air supply source arranged to supply air at a gage pressure of about 3 to 5 psig.

3. The system of claim 2, wherein the air supply source and the valve mechanism are adapted to create a pressure gradient of about 300-500 psig per second.

4. The system of claim 1, wherein the acoustic wave sensor comprises a bulk wave sensor device.

5. The system of claim 1, wherein the acoustic wave sensor comprises a surface acoustic weave device.

6. The system of claim 1, wherein the portion of the conduit includes a bi-stable check valve.

7. The system of claim 1, wherein the portion of the conduit is sized to house therein a second quantity of the calibrant, the second quantity measuring about twenty times the measured quantity.

8. The system of claim 1, wherein the portion of the conduit is sized to house therein a second quantity of the calibrant, the second quantity measuring about twenty times the measured quantity, and wherein the air supply source and the valve mechanism are adapted to create a pressure gradient of about 300-500 psig per second.

9. The system of claim 1, wherein the portion of the conduit includes a check valve, the check valve shiftable between an open position and a closed position in response to the presence of the pressure gradient.

10. The system of claim 1, wherein the portion of the conduit includes a check valve, the check valve shiftable between an open position and a closed position in response to the presence of the pressure gradient, and wherein the air supply source and the valve mechanism are adapted to create a pressure gradient of about 300 psig per second.

10. A sensor calibrating system comprising:
a reservoir for storing a fluid material to be sensed;
a sensor array;
an outlet nozzle;
a conduit providing flow communication between the reservoir and the outlet nozzle, the conduit including a first portion defining a dosing chamber for storing a measured quantity of the fluid material, the dosing chamber being disposed immediately adjacent to the outlet nozzle, the conduit further including a second portion disposed immediately adjacent to the dosing chamber and between the dosing chamber and the reservoir, and means contained in the second portion of the conduit for preventing flow of fluid material from the dosing chamber toward the reservoir, the means responsive to a pressure gradient in the conduit;
a low pressure source in the range of about 3 psig arranged to supply the pressure gradient, the pressure gradient measuring about 300-500 psig per second over a predetermined time period; and
a valve system, the valve system including only a first valve and a second valve, the valve system adapted to apply the pressure gradient to the dosing chamber to thereby pressurize the dosing chamber for the predetermined time period.

11. The device of claim 10, the first valve disposed between the dosing chamber and the outlet nozzle, the first valve being remotely operable.

12. The device of claim 11, the second valve disposed between the pressure source and the dosing chamber, the second valve being remotely operable.

13. A method of calibrating a sensor comprising:
providing a reservoir containing a material to be sensed;
providing a sensor array, the sensor array including an acoustic wave device;
providing an outlet nozzle;
providing a conduit in flow communication between the reservoir and the outlet nozzle, the conduit including a first portion defining a dosing chamber for storing a measured quantity of the fluid material, the dosing chamber being disposed immediately adjacent to the outlet nozzle, the conduit further including a second portion disposed immediately adjacent to the dosing chamber and between the dosing chamber and the reservoir;
providing the second portion of the conduit with means for preventing flow of fluid material from the dosing chamber toward the reservoir, the means responsive to a pressure gradient in the conduit;
providing a low pressure source in the range of about 3 psig;
providing a valve system, the valve system having a first valve disposed between the dosing chamber and the outlet nozzle, the first valve arranged to isolate the dosing chamber from the outlet nozzle, the valve system further including a second valve disposed between the pressure source and the dosing chamber, the second valve arranged to isolate the pressure source from the dosing chamber;
cycling the valve system to apply a pressure gradient of about 300 psig per second over a predetermined time period;
ejecting the measured quantity during the predetermined time period; and
obtaining a sensor reading indicative of the presence of the measured quantity adjacent to the sensor array.
